(19) United States
(12) Patent Application Publication
(10) Pub. No.: US 2012/0116656 A1
(43) Pub. Date: May 10, 2012

(54) Vacuum Boost For Vehicle Braking

(75) Inventors: Douglas Raymond Martin, Canton, MI (US); Dale Scott Crombez, Livonia, MI (US); Moses Alexander Fridman, Birmingham, MI (US)

(73) Assignee: FORD GLOBAL TECHNOLOGIES, LLC, Dearborn, MI (US)

(21) Appl. No.: 12/941,141

(22) Filed: Nov. 8, 2010

(51) Int. Cl. F02D 28/00; F02D 13/00; F02D 9/02

(52) U.S. Cl. 701/110; 123/349; 123/347

(57) ABSTRACT

Power brakes are typically vacuum assisted, with the vacuum provided from the intake manifold. If the engine is commanded to operate for a long period at a condition with low intake manifold vacuum, the vacuum within the brake booster may drop to a level which is marginal or insufficient for a present or subsequent braking operation. To ensure sufficient vacuum in the intake manifold to provide to the brake booster, the engine may be commanded to operate at a condition to increase intake manifold vacuum by one of: adjusting cam timing, increasing engine speed, and increasing EGR. In the case of a stop-start vehicle, the engine speed is increased from zero to a condition that provides the desired vacuum.

### BACKGROUND

1. Technical Field

A system and method for controlling an engine to provide a desired vacuum within a brake booster is disclosed.

2. Background Art

To improve engine efficiency, measures are taken to reduce pumping losses at part load operation. This involves reducing intake manifold pressure. Power brakes are typically vacuum assisted, with the vacuum provided from the intake manifold. If the engine is commanded to operate for a long period at a condition with low intake manifold vacuum, the vacuum within the brake booster may drop to a level which is marginal or insufficient for a present or subsequent braking operation.

### SUMMARY

The present disclosure describes a system and method for ensuring vacuum boost for vehicle braking. The engine is control by: estimating a desired brake booster vacuum that ensures braking of the vehicle at a present operating condition of the vehicle, determining intake manifold vacuum, and increasing engine rpm when the manifold vacuum is less than the desired brake booster vacuum. In one alternative the engine is coupled to a continuously variable transmission (CVT) and the gear ratio in the CVT is adjusted in conjunction with the increasing engine rpm so that vehicle speed substantially equals a demand by an operator of the vehicle. In another alternative, the engine is coupled to an automatic transmission and the transmission is downshifted in conjunction with the increasing engine rpm so that vehicle speed substantially equals a demand by an operator the vehicle. In one alternative, the actual brake booster vacuum is determined and the engine rpm is increased in response to both the manifold vacuum level and the actual brake booster vacuum being less than the estimated brake booster vacuum. The actual brake booster vacuum is determined based on one of a signal from a vacuum sensor coupled to the brake booster and a model of brake booster vacuum. In vehicle including stop-start, i.e., ones in which the engine is shutoff and restarted independently of an operator request, the actual brake booster vacuum is estimated and the engine is restarted when the actual brake booster vacuum is less than the estimated brake booster vacuum. In engines with variable cam timing, cam timing is adjusted to a position which increases manifold vacuum when the manifold vacuum level is less than the estimated brake booster vacuum.

According to some embodiments in which the engine has variable cam timing, a desired brake booster vacuum that ensures braking of the vehicle at a present operating condition of the vehicle is estimated; intake manifold vacuum is determined, possibly by a sensor in the intake; and the intake manifold vacuum when the intake manifold vacuum is less than the estimated brake booster vacuum is increased. The intake manifold vacuum is increased by adjusting cam timing. If such measure is insufficient to provide the desired intake manifold vacuum, engine rpm is increased. In some embodiments, the actions taken to increase intake manifold vacuum are taken only when both the intake manifold vacuum and the actual brake booster vacuum are less than the desired brake booster vacuum. The intake manifold vacuum is further increased by increasing engine speed while adjusting a throttle valve in an engine intake toward a more closed position. The increasing the intake manifold vacuum is further based on a brake pedal coupled to the vehicle being depressed. Increasing the intake manifold vacuum, adjusting the cam timing, and increasing the engine speed are constrained to provide an operator demand for torque. In one embodiment a maximum engine torque is determined to protect vacuum by increasing the intake manifold vacuum, adjusting the cam timing, and increasing the engine speed, but such measures are constrained to provide the lower of an operator demand for torque and the maximum engine torque.

A vehicle is disclosed which includes wheels, brakes proximate the wheels, an internal combustion engine providing torque to the wheels via a drive train, a brake pedal, a brake booster fluidly coupled to an intake manifold of the engine and mechanically coupled to the brake pedal, a master cylinder mechanically coupled to the brake booster with the master cylinder having a hydraulic fluid and coupled to the brakes via hydraulic lines, and an electronic control unit electronically coupled to the engine. The ECU determines intake manifold vacuum, a desired brake booster vacuum that ensures braking of the vehicle at a present operating condition of the vehicle, and actual brake booster vacuum. The ECU commands the engine to increase manifold vacuum when both the intake manifold vacuum and the actual brake booster vacuum are less than the desired brake booster vacuum. In engine with a variable cam timing system coupled to the engine, the increase in intake manifold vacuum includes adjusting cam timing. The intake manifold vacuum is increased by the ECU simultaneously increasing engine speed and adjusting a throttle valve in the intake manifold to a more closed position. The actual brake booster vacuum is based on a signal from a vacuum sensor disposed in the brake booster. In engines in which the ECU commands the engine to stop and restart independently of a command by an operator of the vehicle, the ECU commands the engine to restart when actual brake booster vacuum is less than the desired brake booster vacuum.

### BRIEF DESCRIPTION OF THE DRAWINGS

FIG. 1 is a schematic of a vehicle according to an embodiment of the disclosure; and

FIG. 2 is a flowchart illustrating an embodiment of the disclosure.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated and described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations consistent with the present disclosure, e.g., ones in which components or processes are arranged in a slightly different order than shown in the embodiments in the Figures. Those of ordinary skill in the art will recognize that the teachings of the present disclosure may be applied to other applications or implementations.

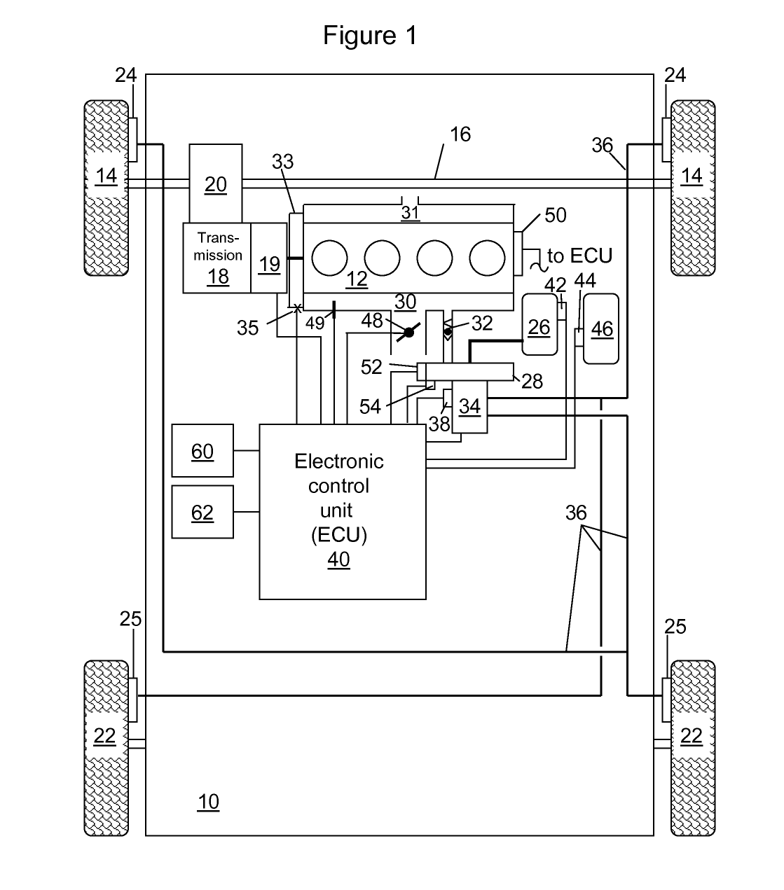

In FIG. 1, a vehicle 10 is shown that is powered by an internal combustion engine 12. Engine 12 drives wheels 14 of an axle 16 through a transmission 18 with a torque converter 19 and a differential 20. Each of the driven wheels 14 and non-driven wheels 22 are provided with a brake 24. Actuation of brakes 24 are initiated by an operator of vehicle 10 depressing a brake pedal 26. A force applied by the vehicle operator is amplified via a brake booster 28, Brake booster is supplied manifold vacuum from an intake manifold 30 coupled to engine 12. A check valve 32 is provided in between brake booster 28 and intake manifold 30 so that when manifold vacuum in intake manifold 30 drops below that which exists in brake booster 28, check valve 32 closes to maintain the vacuum existing in brake booster 28. Brake booster 28 acts upon master cylinder 34 to pressurize fluid within. The pressurized fluid is supplied to brakes 24 through hydraulic lines 36.

Engine 12 also has an exhaust manifold 31. A portion of exhaust gases may be removed from the exhaust gas system and recirculated to the engine intake manifold, known as EGR. An EGR line 33 is shown with an EGR valve 35.

An electronic control unit (ECU) 40 is provided in vehicle 10. ECU 40 is shown as a single unit in FIG. 1. However, ECU 40 can be a distributed computing system with multiple modules. ECU 40 is provided signals from sensors and provides signals to control various vehicle components. Per the embodiment shown in FIG. 1, ECU 40 is provided with pedals sensors 42 and 44 coupled to brake pedal 26 and an accelerator pedal 46, respectively. Sensors 42 and 44 can be linear sensors detecting an amount of pedal travel, angle sensors detecting an amount of rotation of the pedal, or any suitable sensor. In one embodiment, sensor 42 coupled to brake pedal 26 is an on-off sensor indicating when the brake is being depressed. Air flow to engine 12 is provided through intake manifold 30 and controlled by a throttle valve 48. Throttle valve 48 is controlled by ECU 40, the ECU at least partially basing the command to throttle valve 48 on operator demand, as detected via input to accelerator pedal 46. An intake manifold vacuum sensor 49 is disposed in intake manifold 30. Alternatively, a mass air flow sensor can be provided and the intake manifold vacuum can be inferred from engine speed and mass air flow. ECU 40 also controls flow through EGR duct 33 by controlling the position of EGR valve 35.

In one embodiment, engine 12 is equipped with a variable cam timing (VCT) 50 device. The most commonly available VCTs are capable of varying the phasing of intake and/or exhaust valves, depending on whether variable cam timing is provided for both intake and exhaust valves. By adjusting the timing of valve events, based on the engine operating conditions, engine efficiency and/or performance can be improved. Other less common VCTs allow adjustment of the valve open duration. Yet other VCT devices allow for adjusting valve lift. By adjusting the valve phasing and/or lift, efficiency of engine 12 can be improved at part load conditions by reducing pumping work of engine 12, i.e., the amount of energy lost due to drawing in fresh air past throttle valve 48, thereby producing a vacuum in intake manifold 30. A consequence of reducing pumping work is a lower intake manifold pressure and thus less vacuum available for brake booster 28. VCT 50 is commanded by ECU 40, the connection only partially shown.

In the embodiment shown in FIG. 1, a vacuum sensor 52 is coupled to brake booster 28. A signal from vacuum sensor 52 is supplied to ECU 40, from which it can be determined whether sufficient vacuum exists in brake booster 28 for subsequent brake actuations.

Electrical connections shown in FIG. 1 can be, in alternative embodiments, supplanted by wireless communication. ECU 40 is shown coupled to various sensors 60 and various actuators 62. A non-exhaustive list of sensors, which may be coupled to ECU 40 depending on the embodiment, are used to measure engine coolant temperature, ambient air temperature, pressure drop across exhaust gas recirculation (EGR) valve 35, exhaust gas oxygen, intake manifold vacuum, engine speed, vehicle speed, mass air flow, wheel speed, etc.

A non-exhaustive list of other actuators to which ECU 40 may be providing control signals include: fuel injection pulse width to fuel injectors, EGR valve position, anti-lock braking, vehicle stability controller, transmission 18, torque converter coupled to transmission 18, etc.

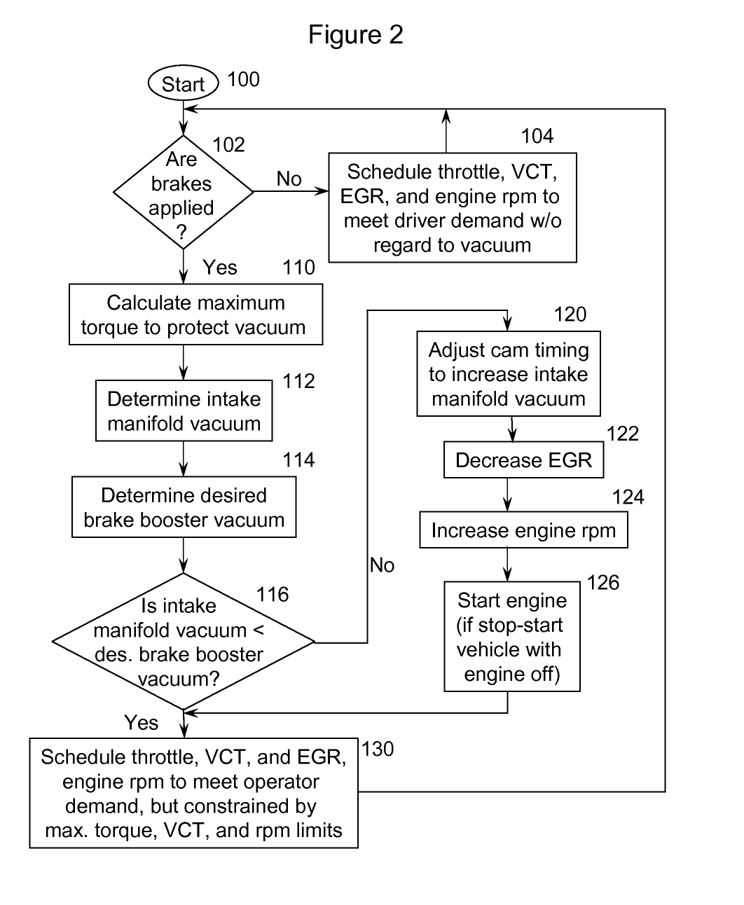

In FIG. 2, an algorithm according to one embodiment of the disclosure starts at 100. In decision block 102, it is determined whether the brakes are applied. If not control passes to block 104 in which the engine parameters, throttle, VCT, and engine rpm are scheduled per normal methods, i.e., without regard to maintaining a particular vacuum level for the brakes. If the brakes are applied control passes to block 110 in which the maximum torque that is possible to protect vacuum for the brakes is determined. Control passes next to block 112 to determine intake manifold vacuum. In one embodiment, the intake manifold vacuum is directly measured; alternatively, intake manifold vacuum is inferred based on other sensors. Control passes to block 114 to determine a desired brake booster vacuum. This is a vacuum which is sufficient to brake the vehicle at the present operating conditions. In one embodiment, the desired brake booster vacuum is determined including an additional amount to provide an excess factor. In block 116, it is determined whether the intake manifold vacuum is less than the desired brake booster vacuum. If so, then there is sufficient vacuum in intake manifold 30, which is coupled to brake booster 28, to brake vehicle 10. In an alternative embodiment, it is determined in decision block 116 whether either intake manifold vacuum or actual brake booster vacuum is less than the desired brake booster vacuum. The actual brake booster vacuum can be based on vacuum sensor 52 in brake booster 26 or by modeling the vacuum based on other engine parameters and braking history. If insufficient vacuum is determined in decision block 116, control passes to block 120. With an engine equipped with variable cam timing the VCT can be adjusted to provide a greater intake manifold vacuum. VCT is typically used to reduce pumping losses due to a pressure difference across the throttle valve, i.e., intake manifold vacuum is reduced. In the case of a desire to increase the intake manifold vacuum to provide for braking, the VCT can be adjusted temporarily to a less desirable position in terms of efficiency. If the VCT has insufficient range to affect intake manifold vacuum or if the engine has no VCT, another measure may be taken to increase intake manifold vacuum. EGR is used in engines for a number of advantages, one of which is an efficiency boost by decreasing intake manifold vacuum and thereby reducing pumping losses. The EGR can be temporarily halted, or decreased in block 122, to provide a desired increase in intake manifold vacuum. If an insufficient increase in intake manifold vacuum is achieved, an additional measure is undertaken in 124. In block 124, engine rpm is increased. If only engine speed is increased, then the vehicle speed is increased, which is undesirable when an operator of the vehicle has not commanded it. Thus, to maintain vehicle speed, a drop in engine gear ratio in the transmission is commanded. If the transmission is a continuously variable transmission (CVT), the gear ratio is reduced as much as desired to obtain the desired engine speed. In a transmission with fixed gear ratios, e.g., a conventional automatic transmission, a downshift is commanded and the engine speed is proportionally increased, which may be slightly more than desired to achieve the vacuum. The reason that increasing engine speed increases engine vacuum is that the operator of the vehicle is demanding a particular power from the engine. As power is torque times engine speed, as engine speed is increased, torque is decreased. A decrease in engine torque is accompanied by an increase in intake manifold vacuum.

Some vehicles are stop-start, i.e., the engine is stopped at a stoplight or possibly even during a coast down to conserve fuel. The engine stopping and restarting is accomplished due to ECU commanding it independently of the operator's control, i.e., this is different from the engine stopping due to a key off as commanded by the operator. In such a vehicle, when the engine is off, there is no vacuum in the intake. Thus, if the vehicle is presently coasting down, the actual brake booster vacuum should be greater than the desired brake booster vacuum. If no, then the engine is started up in block 126 to provide vacuum in the intake manifold with such vacuum available to the brake booster. After a measure, or measures, has been taken to ensure sufficient vacuum in the brake booster, control passes to block 130 in which the engine parameters are scheduled, but constrained by the maximum torque determined in block 110, and as constrained by the limits in VCT, EGR, and engine speed.

In the algorithm in FIG. 2, intake manifold vacuum is provided in response to the brake being applied. Alternatively, checking for sufficient intake manifold vacuum can be performed at all times to ensure that there is sufficient vacuum for any subsequent braking that may be commanded. Such determination is based on present vehicle conditions, such as vehicle speed.

While the best mode has been described in detail, those familiar with the art will recognize various alternative designs and embodiments within the scope of the following claims. Where one or more embodiments have been described as providing advantages or being preferred over other embodiments and/or over prior art in regard to one or more desired characteristics, one of ordinary skill in the art will recognize that compromises may be made among various features to achieve desired system attributes, which may depend on the specific application or implementation. These attributes include, but are not limited to: cost, strength, durability, life cycle cost, marketability, appearance, packaging, size, serviceability, weight, manufacturability, ease of assembly, etc. The embodiments described as being less desirable relative to other embodiments with respect to one or more characteristics are not outside the scope of the disclosure as claimed.

What is claimed:

1. A method to control an engine in a vehicle, comprising:
estimating a desired brake booster vacuum that ensures braking of the vehicle at a present operating condition of the vehicle;
determining intake manifold vacuum; and
increasing engine rpm when the manifold vacuum is less than the desired brake booster vacuum.

2. The method of claim 1 wherein the engine is coupled to a continuously variable transmission (CVT), the method further comprising:
adjusting the gear ratio in the CVT in conjunction with the increasing engine rpm so that vehicle speed substantially equals a demand by an operator of the vehicle.

3. The method of claim 1 wherein the engine is coupled to an automatic transmission, the method further comprising:
downshifting the transmission in conjunction with the increasing engine rpm so that vehicle speed substantially equals a demand by an operator the vehicle.

4. The method of claim 1, further comprising:
determining an actual brake booster vacuum wherein the engine rpm is increased in response to both the manifold vacuum level and the actual brake booster vacuum being less than the estimated brake booster vacuum.

5. The method of claim 4 wherein the actual brake booster vacuum is determined based on one of a signal from a vacuum sensor coupled to the brake booster and a model of brake booster vacuum.

6. The method of claim 1 wherein the vehicle includes stop-start, in which the engine is shutoff and restarted independently of an operator request, the method further comprising:
determining an actual brake booster vacuum;
restarting the engine when the actual brake booster vacuum is less than the estimated brake booster vacuum.

7. The method of claim 1 wherein the engine has variable cam timing, the method further comprising:
adjusting the cam timing to a position which increases manifold vacuum when the manifold vacuum level is less than the estimated brake booster vacuum.

8. A method to control an engine in a vehicle wherein the engine has variable cam timing, comprising:
estimating a desired brake booster vacuum that ensures braking of the vehicle at a present operating condition of the vehicle;
determining intake manifold vacuum; and
increasing the intake manifold vacuum when the intake manifold vacuum is less than the estimated brake booster vacuum wherein the intake manifold vacuum is increased by adjusting cam timing.

9. The method of claim 8, further comprising:
increasing engine rpm when the intake manifold vacuum after the adjustment in the cam timing is still less than the estimated brake booster vacuum.

10. The method of claim 8 wherein the intake manifold vacuum level is based on a signal from a sensor in an engine intake.

11. The method of claim 8, further comprising:
determining an actual brake booster vacuum wherein the intake manifold vacuum is increased in response to both the intake manifold vacuum and the actual brake booster vacuum being less than the desired brake booster vacuum.

12. The method of claim 8 wherein the intake manifold vacuum is further increased by increasing engine speed while adjusting a throttle valve in an engine intake toward a more closed position.

13. The method of claim 8 wherein the increasing the intake manifold vacuum is further based on a brake pedal coupled to the vehicle being depressed.

14. The method of claim 8 wherein increasing the intake manifold vacuum, adjusting the cam timing, and increasing the engine speed are constrained to provide an operator demand for torque.

15. The method of claim 8, further comprising:
determining a maximum engine torque to protect vacuum wherein increasing the intake manifold vacuum, adjusting the cam timing, and increasing the engine speed are constrained to provide the lower of an operator demand for torque and the maximum engine torque.

16. A vehicle, comprising:
wheels;
brakes proximate the wheels;
an internal combustion engine providing torque to the wheels via a drive train;
a brake pedal;
a brake booster fluidly coupled to an intake manifold of the engine and mechanically coupled to the brake pedal;
a master cylinder mechanically coupled to the brake booster, the master cylinder having a hydraulic fluid and coupled to the brakes via hydraulic lines; and
an electronic control unit electronically coupled to the engine wherein the ECU determines intake manifold vacuum, a desired brake booster vacuum that ensures braking of the vehicle at a present operating condition of the vehicle, and actual brake booster vacuum; and the ECU commands the engine to increase manifold vacuum when both the intake manifold vacuum and the actual brake booster vacuum are less than the desired brake booster vacuum.

17. The vehicle of claim 16, further comprising:
a variable cam timing system coupled to the engine wherein the increasing intake manifold vacuum includes adjusting cam timing.

18. The vehicle of claim 16 wherein the intake manifold vacuum is increased by the ECU simultaneously increasing engine speed and adjusting a throttle valve in the intake manifold to a more closed position.

19. The vehicle of claim 16 wherein the actual brake booster vacuum is based on a signal from a vacuum sensor disposed in the brake booster.

20. The vehicle of claim 16 wherein the ECU commands the engine to stop and restart independently of a command by an operator of the vehicle and the ECU commands the engine to restart when actual brake booster vacuum is less than the desired brake booster vacuum.
